(19) United States
(12) Patent Application Publication
(10) Pub. No.: US 2024/0073164 A1
(43) Pub. Date: Feb. 29, 2024

(54) ELECTRONIC MESSAGING INFORMATION EXTRACTION METHOD AND APPARATUS

(71) Applicant: YAHOO ASSETS LLC, Dulles, VA (US)

(72) Inventors: Kirstin EARLY, San Jose, CA (US); Rao SHEN, Sunnyvale, CA (US); Kostas TSIOUTSIOULIKLIS, Saratoga, CA (US)

(21) Appl. No.: 17/821,618

(22) Filed: Aug. 23, 2022

(51) Int. Cl. H04L 51/063; H04L 51/21; H04L 51/42

(52) U.S. Cl. CPC H04L 51/063; H04L 51/21; H04L 51/42

(57) ABSTRACT

Techniques for automatic intelligent information extraction from electronic messages are disclosed. In one embodiment, a computerized method is disclosed comprising obtaining a corpus of electronic messages, generating training data using the corpus of electronic messages, training an attribute generation model using the training data, analyzing an electronic message from a message folder and generating model input based on the analysis, obtaining model output from the attribute generation model based on the model input, the model output comprising, in connection with a respective type of information, a set of attribute values for a set of attributes corresponding to the respective type of information, and generating a presentation, for display at a user computing device, the presentation comprising information based at least in part on the set of attribute values associated with the set of attributes.

### FIELD OF THE DISCLOSURE

The present disclosure relates to improvements to messaging information extraction systems and specifically to providing novel systems and methods providing a trained model for use in determining a mapping between messaging information and data objects representing the messaging information.

### BACKGROUND

A large corpus of electronic messages are machine generated messages. For example, most electronic mail, or email, messages and corresponding folders (e.g., inboxes) are comprised of machine-generated messages (e.g., email messages generated automatically by computing devices tools, such as automated scripts, programs, etc.). In many cases, the email messages originate from commercial entities and organizations. For example, automatically-generated email messages might contain a shipment notification, flight itinerary, purchase or order receipt, calendar event, newsletter, etc.

### SUMMARY

The present disclosure provides novel systems and methods for automatic intelligent information extraction using a novel multitask machine learning model capable of translating message contents into structured information comprising data extracted from the message contents and relationships between the extracted data. In accordance with one or more embodiments, a message type can be determined.

The vast majority (e.g., around 95%) of non-spam electronic mail traffic transmitted via the Internet is machine generated. However, there is no standardization (e.g., automated script standardization across senders and/or electronic message types) used in generating the electronic messages.

Presently, data extraction from electronic messages requires manual generation of data extraction rules. Manual generation of data extraction rules requires that a number of human editors review electronic messages and manually generate each data extraction rule based on the review. For example, an email message containing a purchase receipt received from an online vendor is reviewed by a human editor and the human editor defines one or more data extraction rules for extracting data from the email message. Since there is no standardization across senders (or within senders, as the same sender can use multiple email templates) and no standardization across message types, human editors must review each message type for each sender and template and generate one or more extraction rules based on the review.

In addition, human editors are needed to update or generate new extraction rules anytime a sender makes changes to an automatically-generated electronic message (such as by making changes to the script used to generate the electronic message). Given the magnitude of email message traffic, the lack of standardization across senders and message types and the likelihood of changes to the scripts used in the generation of the electronic messages, it is not feasible to manually generate data extraction rules using human editors. The cost alone of using human editors makes manual generation of extraction rules prohibitive. In addition, the use of human editors introduces latency in the process, which results in a delay in the availability extraction rules as well as a delay in the availability of the extracted data. Given the sheer volume of emails being sent each day and the changing nature of machine-generated emails, extraction by humans is no longer possible at the scale required in modern email systems.

Disclosed systems and methods address problems inherent in prior approaches and provide an automatic intelligent electronic message information identification and extraction using a novel multitask machine learning model capable of translating message contents into structured information comprising attributes and corresponding attribute values and identifying relationships among the information using data extracted from the message contents. This presents improvements to the timeliness of, and availability of, data automatically extracted from electronic messages, which improves the functionality of other systems, such as and without limitation electronic message systems, recommendation systems, online electronic commerce (ecommerce systems), and the like.

In accordance with embodiments of the present disclosure, statistical machine learning can be used to train an attribute generation model to generate attribute values for one or more sets of attributes based on model input generated using data extracted from an electronic message (e.g., an electronic message from a user's messaging folder). The model input can comprise portions of the electronic message (e.g., message subject and message body). Embodiments of the present disclosure can analyze the electronic message to identify parts (e.g., subject and body) of the message. By way of a non-limiting example, analysis of the message can include parsing the message to identify its parts.

By way of a further non-limiting example, an electronic message (e.g., an electronic mail message) can be expressed using a markup-language (e.g., Hypertext Markup Language, or HTML), and an HTML parser can be used to locate and extract parts of the message using markup-language features, such as and without limitation markup-language (HTML) elements (e.g., anchor, head, title, body, image, paragraph, link, etc. elements) and corresponding attributes.

In accordance with one or more embodiments, the model can be trained using a set of training data comprising a number of training instances. Each training instance can comprise parts of an electronic message (from a corpus of electronic messages used to train the model) and at least one information type. Each information type (also referred to herein as an extraction type) can be considered to be a characterization, or classification, of the contents of (and information being conveyed in) an electronic message. Each information type can have an associated set of attributes and corresponding attribute values.

Some examples of information types include without limitation Order, ParcelDelivery, Coupon, etc. By way of some non-limiting examples, the set of attributes for a ParcelDelivery information (or extraction) type can comprise ItemShipped, Product, Name, Price, TrackingNumber, and the like attributes.

In accordance with one or more embodiments, a multi-label extraction classifier (MEC) can be used to analyze an electronic message's contents (e.g., sender, subject, message body, etc.) and predict which one or more types of information apply to the electronic message. Each information (or extraction) type can have a set of attributes and corresponding attribute values that can be determined by the attribute generation model using model input.

The MEC can further generate a score (e.g., a level of confidence) for each information type, which can be used with a threshold to determine whether a respective information type applies to the electronic message. As discussed in more detail below, each information type associated with an electronic message used to generate a training instance can be used as a label for the training instance.

Embodiments of the present disclosure train a statistical machine learning model (an attribute generation model) to take information extracted from an electronic message as input (or model input) and identify, for the message, one or more information types and, for each information type, a set of attribute values corresponding to a set of attributes corresponding to the information type. Additionally, the model can be trained to identify, for each information type, a level of confidence in the information type.

It will be recognized from the disclosure herein that embodiments of the instant disclosure provide improvements to a number of technology areas, for example those related to systems and processes that handle or process electronic messages, such as but not limited to, online electronic mail systems, digital text messaging systems, etc. as well as travel assistance systems, search engines, online advertising systems, online recommendation systems and the like.

The disclosed systems and methods can effectuate increased speed and efficiency in the ways that data is automatically extracted, as the disclosed systems and methods, inter alia, eliminate the use of human editors in data extraction. Data can be automatically extracted from electronic messages, and the automatically-extracted data can be used in a number of ways, including providing data extracted from one or more electronic messages in a summarized manner to users or other entities through the disclosed systems and methods. As the disclosed systems and methods automatically extract and present data from the electronic message(s), the need to search for or open the electronic messages from which the data is automatically extracted is avoided, thus improving access, for a user of electronic messages, to content contained in electronic messages.

According to some embodiments, the disclosed systems and methods first obtain a set of training data comprising a number of training instances. Each training instance can comprise data extracted from an electronic message (from a corpus of electronic messages used to train the model) and a set of labels indicating which information types are applicable (and/or inapplicable) to the electronic message. The set of labels can be in the form of a label vector with each entry corresponding to a respective information type. For a given label/information type, the entry can be a binary value indicating an applicability or inapplicability (e.g., predicted by the MEC) of the label/information type for the training instance. Alternatively, the entry can be a probability, or level of confidence, (e.g., predicted by the MEC) of the applicability/inapplicability of the label/information type. As yet another alternative, the entry can be a combination of both the binary value and the probability/level of confidence.

The disclosed systems and methods can then use the training data comprising the training instances to train the attribute generation model (e.g., a sequence-to-sequence model) to generate model output comprising a set of attributes and a corresponding set of attribute values. In accordance with disclosed embodiments, the trained attribute generation model can provide a number of attribute/attribute value pairs in response to model input. In accordance with one or more embodiments, the model input can be determined by analyzing an electronic message (e.g., an electronic message from a message folder of a user) and extracting parts (e.g., subject and message body contents) based on the analysis.

By way of a non-limiting example, the model can be a sequence-to-sequence model, where the model input comprises a sequence of tokens and the model output comprises another sequence of tokens. The sequence of tokens output by the attribute generation model can comprise attributes and corresponding attribute values. By way of a non-limiting example, the output token sequence can identify a set of structured objects. By way of a further non-limiting example, the structure objects can be expressed using a scripting language such as and without limitation the JavaScript® Object Notation (JSON). The structured model output can further identify relationships between attributes (and corresponding attribute values). By way of a non-limiting example, relationships among attributes (and corresponding attribute values) can be expressed using a nesting (or hierarchy) of attributes (and corresponding attribute values).

In accordance with one or more embodiments, the attribute generation model can comprise a bidirectional recurrent neural network (RNN) encoder and decoder with long short-term (LSTM) cells and attention. Additionally, the attribute generation model can comprise an information-type prediction layer enabling the attribute generation model to predict (as part of the model output) which information type(s) correspond to the model input. In accordance with one or more embodiments, the model input can comprise label/information type information (e.g., a label vector such as that determined for each training instance) from the MEC.

In accordance with one or more embodiments, the information type prediction output by the attribute generation model can be used with the extraction type prediction output by the MEC to tune the attribute generation model during training.

In accordance with one or more embodiments, the sequence of tokens input to the model can be generated from parts of an electronic message (e.g., an electronic message from a messaging folder of a user) and a special separator token can be used to segment the input token sequence in accordance with the parts of the electronic message. For example, a separator token can be used to separate the sequence of tokens corresponding to the subject of the electronic message from the sequence of tokens corresponding to the body of the electronic message.

In accordance with one or more embodiments, an electronic message can be analyzed to generate the model input (e.g., the sequence of tokens). In accordance with at least one such embodiment, information used to generate the model input can be extracted from the electronic message via an analysis of elements of the electronic message. By way of a non-limiting example, the message elements can comprise one or more body and header elements included in the electronic message. By way of a further non-limiting example, analysis of the message elements can be used to locate and extract the subject and sender information (used as model input) from the header element(s) of the electronic message, and the body information (used as model input) from the body element(s) of the electronic message.

In accordance with one or more embodiments, the body element(s) of the electronic message can comprise one or more HTML elements and corresponding attributes (of the HTML elements), which can be used to identify and extract the body information (used as model input) from the electronic message.

In accordance with one or more embodiments, other information (in addition to the subject, sender and body information) can be located and extracted from the electronic message and used as model input. By way of one non-limiting example, at least one HTML element (e.g., from the body element(s) of the electronic message) can be used to identify an image contained (and/or referenced) in the electronic message. At least one attribute (e.g., an alt attribute) corresponding to an HTML element (of the at least one HTML element) can include a description (e.g., textual description) of the contents of the image. In accordance with one or more embodiments, at least a portion of the model input can be generated based on at least one of the image contents and the description of the image contents.

In accordance with one or more embodiments, the model output provided by the attribute generation model, which comprises attributes and corresponding attribute values, can be used to provide information (e.g., via a user interface) that is based on one or more of the attributes and the corresponding attribute value of each of the one or more attributes.

It will be recognized from the disclosure herein that embodiments of the instant disclosure provide improvements to a number of technology areas, for example those related to systems and processes that handle or process electronic messages, such as but not limited to, online electronic mail systems, digital text messaging systems, etc. as well as travel assistance systems, search engines, online advertising systems, online recommendation systems and the like.

The disclosed systems and methods can effectuate increased speed and efficiency in the ways that data is automatically extracted, as the disclosed systems and methods, inter alia, eliminate the use of human editors in data extraction. Data can be automatically extracted from electronic messages, and the automatically-extracted data can be used in a number of ways, including providing data extracted from one or more electronic messages in a user interface (e.g., in a summarized manner) to users or other entities through the disclosed systems and methods. As the disclosed systems and methods automatically extract and present data from the electronic message(s), the need to search for or open the electronic messages from which the data is automatically extracted is avoided, thus improving access, for a user of electronic messages, to content contained in electronic messages.

In accordance with one or more embodiments, a method is disclosed which includes obtaining, by a computing device, a corpus of electronic messages; generating, by the computing device, training data comprising a set of training instances using the corpus of electronic messages, each training instance, of the set of training instances, comprising data extracted from a respective electronic message from the corpus of electronic messages and labeling information indicating at least one type of information included in the respective electronic message; training, by the computing device, an attribute generation model using the training data; analyzing, by the computing device, an electronic message from a message folder and generating model input based on the analysis; obtaining, by the computing device, model output from the attribute generation model based on the model input, the model output comprising, in connection with a respective type of information, a set of attribute values for a set of attributes corresponding to the respective type of information; and generating, via the computing device, a presentation, for display at a user computing device, the presentation comprising information based at least in part on the set of attribute values associated with the set of attributes.

In accordance with one or more embodiments, a non-transitory computer-readable storage medium is provided, the non-transitory computer-readable storage medium tangibly storing thereon, or having tangibly encoded thereon, computer readable instructions that when executed cause at least one processor to perform a method for automatic extraction of data from electronic messages.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a schematic block diagram illustrating components of an exemplary system in accordance with embodiments of the present disclosure;

FIG. 4 is a flowchart illustrating steps performed in accordance with some embodiments of the present disclosure;

FIG. 5 is a diagram of an exemplary example of an attribute generation model in accordance with some embodiments of the present disclosure;

FIG. 6 is a diagram of an exemplary example of a non-limiting embodiment in accordance with some embodiments of the present disclosure;

FIG. 7 includes non-limiting user interface examples populated using attribute generation model output in accordance with one or more embodiments of the present disclosure; and

FIG. 8 is a block diagram illustrating the architecture of an exemplary hardware device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations. For example, a simple smart phone, phablet or tablet may include a numeric keypad or a display of limited functionality, such as a monochrome liquid crystal display (LCD) for displaying text. In contrast, however, as another example, a web-enabled client device may include a high resolution screen, one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

A client device may include or may execute a variety of possible applications, such as a client software application enabling communication with other devices, such as communicating one or more messages, such as via email, for example Yahoo!® Mail, short message service (SMS), or multimedia message service (MMS), for example Yahoo! Messenger®, including via a network, such as a social network, including, for example, Tumblr®, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing or displaying various forms of content, including locally stored or streamed video, or games (such as fantasy sports leagues). The foregoing is provided to illustrate that claimed subject matter is intended to include a wide range of possible features or capabilities.

The detailed description provided herein is not intended as an extensive or detailed discussion of known concepts, and as such, details that are known generally to those of ordinary skill in the relevant art may have been omitted or may be handled in summary fashion.

The principles described herein may be embodied in many different forms. By way of background, an electronic message can be an electronic mail (or email) message, short message, social media (or other) post, etc. While embodiments are described using email as an example, it should be apparent that any type of electronic message can be used.

As discussed above, the vast majority of messages are machine generated, and there is no standardization used in generating the electronic messages.

Presently, data extraction from electronic messages requires manual generation of data extraction rules. Manual generation of data extraction rules requires that a number of human editors review electronic messages and manually generate each data extraction rule based on the review. For example, an email message containing a purchase receipt received from an online vendor is reviewed by a human editor and the human editor defines one or more data extraction rules for extracting data from the email message. Since there is no standardization across senders (or within senders, as the same sender can use multiple email templates) and no standardization across message types, human editors must review each message type for each sender and template and generate one or more extraction rules based on the review.

In addition, human editors are needed to update or generate new extraction rules anytime a sender makes changes to an automatically-generated electronic message (such as by making changes to the script used to generate the electronic message). Given the magnitude of email message traffic, the lack of standardization across senders and message types and the likelihood of changes to the scripts used in the generation of the electronic messages, it is not feasible to manually generate data extraction rules using human editors. The cost alone of using human editors makes manual generation of extraction rules prohibitive. In addition, the use of human editors introduces latency in the process, which results in a delay in the availability extraction rules as well as a delay in the availability of the extracted data. Given the sheer volume of emails being sent each day and the changing nature of machine-generated emails, extraction by humans is no longer possible at the scale required in modern email systems.

Disclosed systems and methods address problems inherent in prior approaches and provide an automatic intelligent electronic message information identification and extraction using a novel multitask machine learning model capable of translating message contents into structured information comprising attributes and corresponding attribute values and identifying relationships among the information using data extracted from the message contents. This presents improvements to the timeliness of, and availability of, data automatically extracted from electronic messages, which improves the functionality of other systems, such as and without limitation electronic message systems, recommendation systems, online electronic commerce (ecommerce systems), and the like.

As such, the instant disclosure provides a novel solution addressing the immediate demand for an automated system, application and/or platform that automatically and intelligently identifies and extracts data from electronic messages.

It will be recognized from the disclosure herein that embodiments of the instant disclosure provide improvements to a number of technology areas, for example those related to systems and processes that handle or process electronic messages, such as but not limited to, online electronic mail systems, digital text messaging systems, etc. as well as travel assistance systems, search engines, online advertising systems, online recommendation systems and the like.

The disclosed systems and methods can effectuate increased speed and efficiency in the ways that data is automatically extracted, as the disclosed systems and methods, inter alia, eliminate the use of human editors in data extraction. Data can be automatically extracted from electronic messages, and the automatically-extracted data can be used in a number of ways, including providing data extracted from one or more electronic messages in a summarized manner to users or other entities through the disclosed systems and methods. As the disclosed systems and methods automatically extract and present data from the electronic message(s), the need to search for or open the electronic messages from which the data is automatically extracted is avoided, thus improving access, for a user of electronic messages, to content contained in electronic messages.

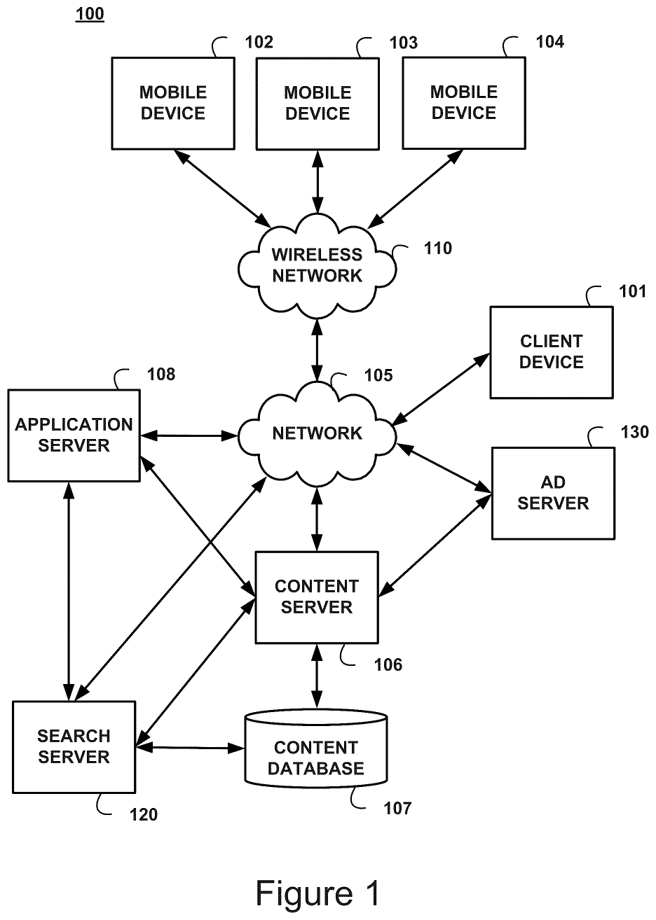

Certain embodiments will now be described in greater detail with reference to the figures. The following describes components of a general architecture used within the disclosed system and methods, the operation of which with respect to the disclosed system and methods being described herein. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as, by way of non-limiting examples, content server 106, application (or “App”) server 108, search server 120 and advertising (“ad”) server (not shown).

One embodiment of mobile devices 102-104 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, smart watch, tablet computers, phablets, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and an HD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, searching for, viewing and/or sharing photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Devices 101-104 may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Network 105 is configured to couple content server 106, application server 108, or the like, with other computing devices, including client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, QUIC (Quick UDP Internet Connection), DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within or accessible to an electronic social networking site. A social network refers generally to an electronic network of individuals, such as acquaintances, friends, family, colleagues, or co-workers, that are coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communicate with other members of a social network via a variety of devices. Multi-modal communication technologies refers to a set of technologies that permit interoperable communication across multiple devices or platforms, such as cell phones, smart phones, tablet computing devices, phablets, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site or service, such as streaming media site/service (e.g., YouTube®), an email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers, desktop computers, multiprocessor systems, microprocessor-based or programmable consumer electronics, network PCs, servers, and the like.

Content server 106 can further provide a variety of services that include, but are not limited to, streaming and/or downloading media services, search services, email services, photo services, web services, social networking services, news services, third-party services, audio services, video services, instant messaging (IM) services, SMS services, MMS services, FTP services, voice over IP (VOIP) services, or the like. Such services, for example a video application and/or video platform, can be provided via the application server 108, whereby a user is able to utilize such service upon the user being authenticated, verified or identified by the service. Examples of content may include images, text, audio, video, or the like, which may be processed in the form of physical signals, such as electrical signals, for example, or may be stored in memory, as physical states, for example.

An ad server comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with users. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is advertisers will pay higher advertising rates when they believe their ads are being placed in or along with highly relevant content that is being presented to users. Reductions in the time needed to quantify a high quality ad placement offers ad platforms competitive advantages. Thus higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108 and 120 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In some embodiments, users are able to access services provided by servers 106, 108 and/or 120. This may include, in a non-limiting example, authentication servers, search servers, email servers, social networking services servers, SMS servers, IM servers, MMS servers, e8hange servers, photo-sharing services servers, and travel services servers, via the network 105 using their various devices 101-104. In some embodiments, applications, such as a streaming video application (e.g., YouTube®, Netflix®, Hulu®, iTunes®, Amazon Prime®, HBO Go®, and the like), blog, photo storage/sharing application or social networking application (e.g., Flickr®, Tumblr®, and the like), can be hosted by the application server 108 (or content server 106, search server 120 and the like). Thus, the application server 108 can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108, 120, or an ad server 130 or ad network.

Moreover, although FIG. 1 illustrates servers 106, 108 and 120 as single computing devices, respectively, the disclosure is not so limited. For example, one or more functions of servers 106, 108 and/or 120 may be distributed across one or more distinct computing devices. Moreover, in one embodiment, servers 106, 108 and/or 120 may be integrated into a single computing device, without departing from the scope of the present disclosure.

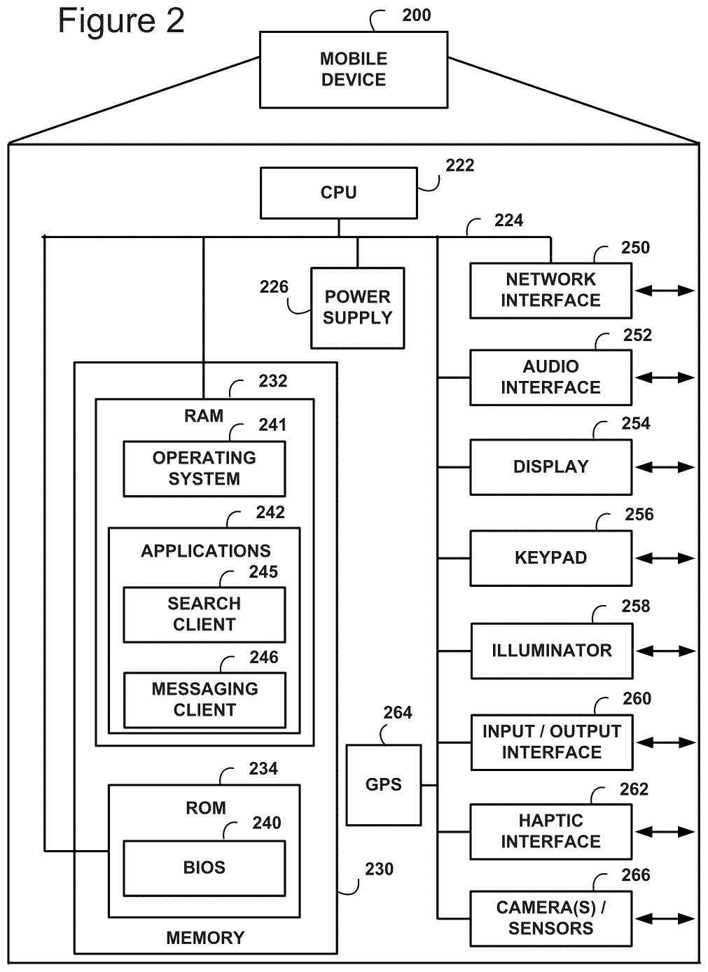

FIG. 2 is a schematic diagram illustrating a client device showing an example embodiment of a client device that may be used within the present disclosure. Device 200 may include many more or less components than those shown in FIG. 2. However, the components shown are sufficient to disclose an illustrative embodiment for implementing the present disclosure. Device 200 may represent, for example, client device 101 and mobile devices 102-104 discussed above in relation to FIG. 1.

As shown in the figure, device 200 includes a processing unit (CPU) 222 in communication with a mass memory 230 via a bus 224. Device 200 also includes a power supply 226, one or more network interfaces 250, an audio interface 252, a display 254, a keypad 256, an illuminator 258, an input/output interface 260, a haptic interface 262, an optional global positioning systems (GPS) transceiver 264 and a camera(s) or other optical, thermal or electromagnetic sensors 266. Device 200 can include one camera/sensor 266, or a plurality of cameras/sensors 266, as understood by those of skill in the art. The positioning of the camera(s)/sensor(s) 266 on device 200 can change per device 200 model, per device 200 capabilities, and the like, or some combination thereof.

Device 200 may optionally communicate with a base station (not shown), or directly with another computing device. Network interface 250 includes circuitry for coupling device 200 to one or more networks, and is constructed for use with one or more communication protocols and technologies as discussed above.

Optional GPS transceiver 264 can determine the physical coordinates of device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of device 200 on the surface of the Earth. In an embodiment, device 200 may, through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of device 200. The mass memory also stores an operating system 241 for controlling the operation of device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by device 200 to store, among other things, applications 242 and/or other data. For example, data stores may be employed to store information that describes various capabilities of device 200. The information may then be provided to another device based on any of a variety of events, including being sent as part of a header during a communication, sent upon request, or the like. At least a portion of the capability information may also be stored on a disk drive or other storage medium (not shown) within device 200.

Applications 242 may include computer executable instructions which, when executed by device 200, transmit, receive, and/or otherwise process audio, video, images, and enable telecommunication with a server and/or another user of another client device. Other examples of application programs or “apps” in some embodiments include browsers, calendars, contact managers, task managers, transcoders, photo management, database programs, word processing programs, security applications, spreadsheet programs, games, search programs, and so forth. Applications 242 may further include search client 245 that is configured to send, to receive, and/or to otherwise process a search query and/or search result using any known or to be known communication protocols. Although a single search client 245 is illustrated it should be clear that multiple search clients may be employed. For example, one search client may be configured to enter a search query message, where another search client manages search results, and yet another search client is configured to manage serving advertisements, IMs, emails, and other types of known messages, or the like.

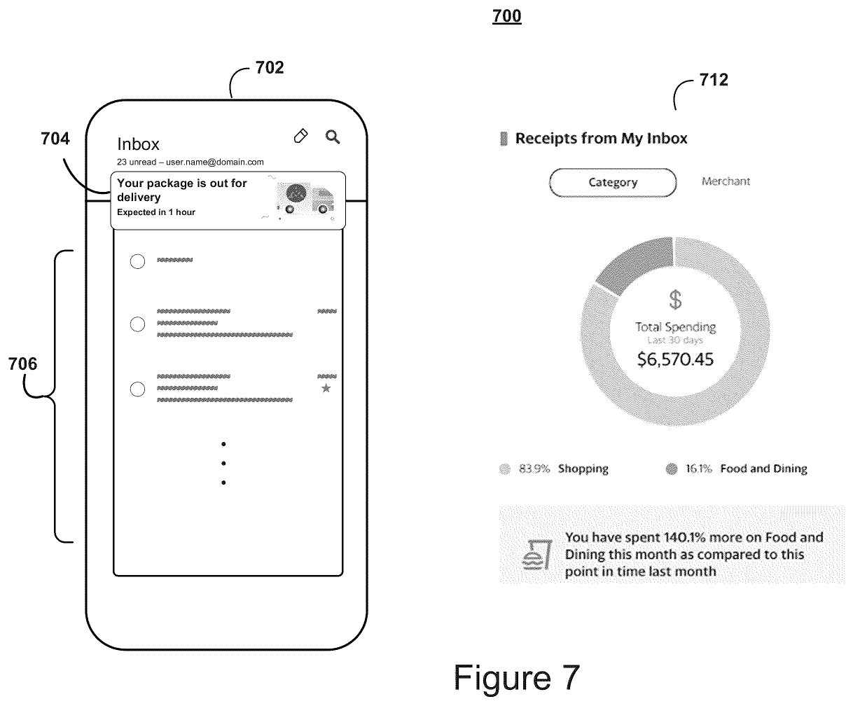

As shown in FIG. 2, applications 242 can include a messaging client 246 enabling communication of one or more messages between devices via email, short message service (SMS), multimedia message service (MMS), or the like. Messaging client 246 can provide a user interface for creating new messages, displaying received messages, etc. In accordance with one or more embodiments, the user interface of messaging client 246 can be used to display data extracted from one or more messages and/or information generated using extracted data. FIG. 7, described below, provides some non-limiting user interface examples that can be generated in accordance with embodiments of the present disclosure.

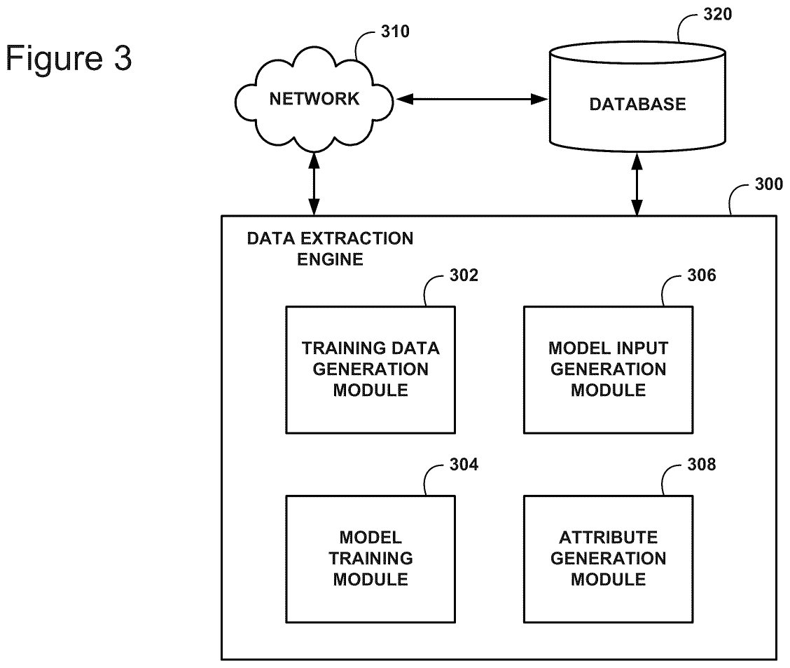

FIG. 3 is a block diagram illustrating the components for performing the systems and methods discussed herein. FIG. 3 includes data extraction engine 300, network 310 and database 320. The engine 300 can be a special purpose machine or processor and could be hosted by an application server, content server, social networking server, web server, search server, content provider, email service provider, ad server, user's computing device, and the like, or any combination thereof.

According to some embodiments, the engine 300 can be embodied as a stand-alone application that executes on a computing device, user computing device, server computing device, etc. In some embodiments, the engine 300 can function as an application installed on the computing device, and in some embodiments, such application can be a web-based application accessed by the computing device over a network.

The database 320 can be any type of database or memory, and can be associated with a server on a network (such as and without limitation a content server, search server, application server, electronic messaging system server, etc.,) or a user's device. Database 320 comprises a dataset of data and metadata associated with local and/or network information related to users, services, applications, content (e.g., video) and the like. Such information can be stored and indexed in the database 320 independently and/or as a linked or associated dataset. It should be understood that the data (and metadata) in the database 320 can be any type of information and type, whether known or to be known, without departing from the scope of the present disclosure.

In some embodiments, the database 320 can include, for purposes of identifying and extracting information from electronic messaging data and generating attribute values, user data including electronic messages, attribute sets and corresponding attribute values, etc.

According to some embodiments, the user data stored in database 320 can include, but is not limited to, information associated with a user's profile, user interests, user behavioral information, user attributes, user preferences or settings, user demographic information, user location information, user biographic information, and the like, or some combination thereof. In some embodiments, at least some of the user profile data can be determined using the attribute and corresponding attribute values generated from data extracted from the electronic messages in accordance with embodiments of the present disclosure. It should be understood that the data (and metadata) in the database 320 can be any type of information related to a user, content, a device, an application, a service provider, a content provider, whether known or to be known, without departing from the scope of the present disclosure.

The network 310 can be any type of network such as, but not limited to, a wireless network, a local area network (LAN), wide area network (WAN), the Internet, or a combination thereof. The network 310 facilitates connectivity of the engine 300, and the database of stored resources 320. Indeed, as illustrated in FIG. 3, the engine 300 and database 320 can be directly connected by any known or to be known method of connecting and/or enabling communication between such devices and resources.

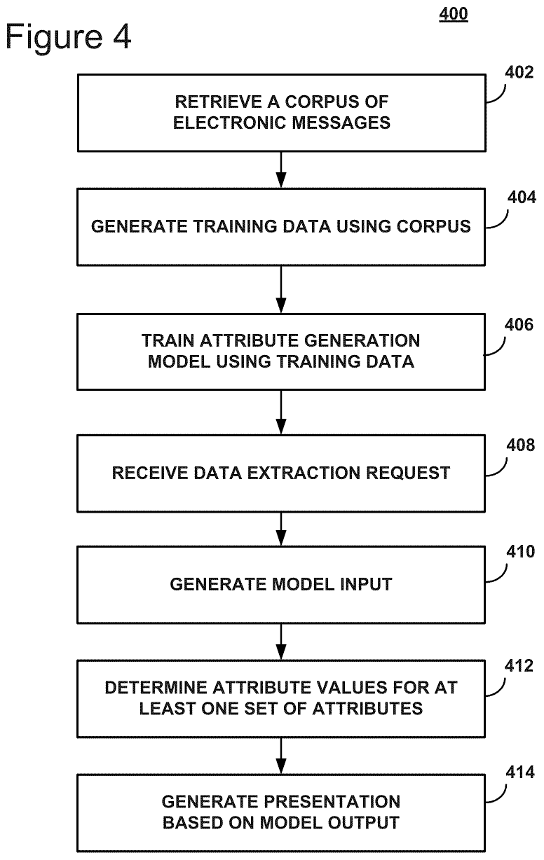

The principal processor, server, or combination of devices that comprises hardware programmed in accordance with the special purpose functions herein is referred to for convenience as engine 300, and includes training data generation module 302, model training module 304, model input generation module 306, and attribute generation module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed with reference to FIG. 4.

As discussed in more detail below, the information processed by the engine 300 can be supplied to the database 320 in order to ensure that the information housed in the database 320 is up-to-date as the disclosed systems and methods leverage real-time information, as discussed in more detail below.

FIG. 4 provides a process flow overview in accordance with one or more embodiments of the present disclosure. Process 400 of FIG. 4 details steps performed in accordance with exemplary embodiments of the present disclosure for automatic intelligent information extraction. According to some embodiments, as discussed herein with relation to FIG. 4 the process involves generating training data using a corpus of electronic messages, training an attribute generation model to generate attribute values for at least one set of attributes based on model input generated using data extracted from an electronic message (e.g., an email message, or other message, from a user's messaging folder) as input, as discussed in more detail below.

At step 402, which can be performed by training data generation module 302 of engine 300, a corpus of electronic messages can be retrieved. By way of a non-limiting example, training data generation module 302 can obtain a corpus of electronic messages from database 320. At step 404, which can be performed by module 302, the corpus of electronic messages can be used to generate a set of training data. The set of training data can comprise a number of training instances.

Each training instance can comprise data extracted from an electronic message (from the corpus of electronic messages used to train the model) and a set of labels (e.g., indicating applicable/inapplicable information types) for the electronic message. The set of labels can be in the form of a label vector with each entry corresponding to a respective information type. For a given label/information type, the entry can be a binary value indicating an applicability or inapplicability (e.g., predicted by the MEC) of the label/information type for the training instance. Alternatively, the entry can be a probability, or level of confidence, (e.g., predicted by the MEC) of the applicability/inapplicability of the label/information type. As yet another alternative, the entry can be a combination of both the binary value and the probability/level of confidence.

In accordance with disclosed embodiments, each training instance can comprise parts of an electronic message (from a corpus of electronic messages used to train the model) and at least one information type. Each information type (also referred to herein as an extraction type) can be considered to be a characterization, or classification, of the contents of (and information being conveyed in) an electronic message. Each information type can have an associated set of attributes and corresponding attribute values.

Some examples of extraction types include without limitation Order, ParcelDelivery, Coupon, etc. By way of some non-limiting examples, the set of attributes for a ParcelDelivery information (or extraction) type can comprise ItemShipped, Product, Name, Price, TrackingNumber, and the like attributes.

As discussed herein, in accordance with one or more embodiments, a multi-label extraction classifier (MEC) can be used to analyze an electronic message's contents (e.g., sender, subject, message body, etc.) and predict which one or more types of information apply to the electronic message. Each information (or extraction) type can have a set of attributes and corresponding attribute values that can be determined by the attribute generation model using model input.

The MEC can further generate a score (e.g., a level of confidence) for each information type, which can be used with a threshold to determine whether a respective information type applies to the electronic message. Each information type(s) associated with an electronic message used to generate a training instance can be used as a label for the training instance (and/or as a feature included in model input generated by model input generation module 306, at step 410).

At step 406, which can be performed by model training module 304, the training data comprising the training instances (generated at step 404) can be used to train a statistical machine learning model (an attribute generation model) to take information extracted from an electronic message as input (or model input) and identify, for the message and one or more information types, a set of attribute values corresponding to a set of attributes corresponding to the information type(s).

By way of a non-limiting example, the attribute generation model can be a sequence-to-sequence model, which takes as input a sequence of tokens and generates a sequence of tokens as output. By way of a further non-limiting example, the sequence of tokens output by the attribute generation model can comprise both attributes and attribute values.

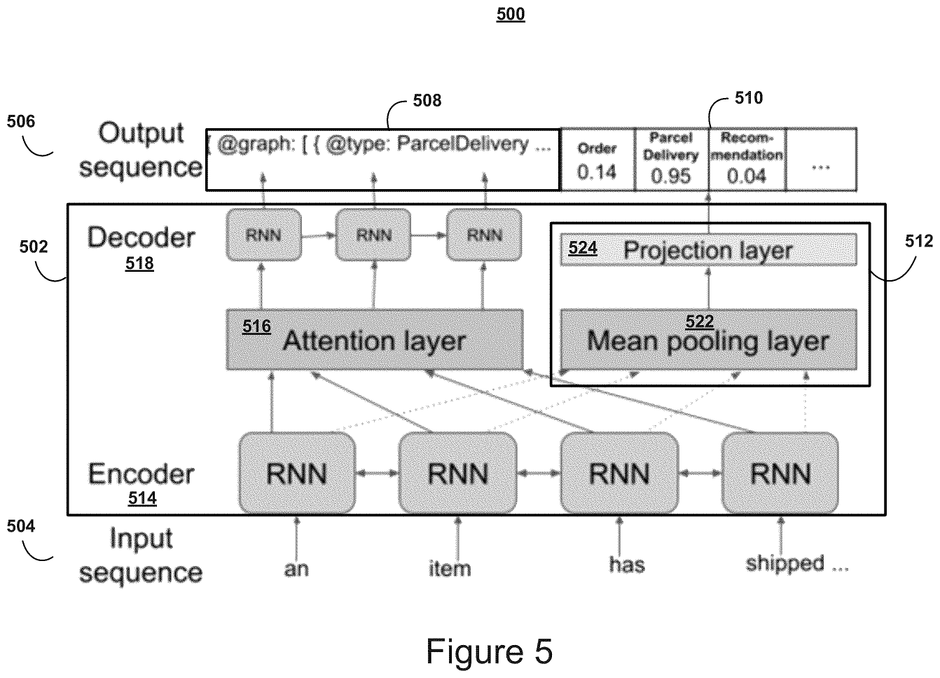

FIG. 5 is a diagram of an exemplary example of an attribute generation model in accordance with some embodiments of the present disclosure. As shown in example 500 of FIG. 5, attribute generation model 502 can comprise a bidirectional recurrent neural network (RNN) encoder layer 514 and decoder layer 518 with long short-term memory (LSTM) cells and an attention layer 516.

In accordance with one or more embodiments, encoder layer 514 and decoder layer 518 can each comprise a set of recurrent neural networks (RNNs). As shown in example 500, each RNN of the encoder layer 514 can receive at least one token in input sequence 504, and each RNN of decoder layer 518 can output at least one token in output sequence 506.

Embodiments of the present disclosure train attribute generation model 502 to take information extracted from an electronic message as input (e.g., input sequence 504) and identify, for the message, one or more information types (e.g., output 510) and, for each information type, a set of attribute values corresponding to a set of attributes corresponding to the extraction type (e.g., output 508). Additionally, attribute generation model 502 can be trained to identify, for each information type, a level of confidence in the extraction type.

In accordance with one or more embodiments, model 502 can be a multitask model, comprising an information-type prediction component 512 enabling the attribute generation model 502 to predict (as part of the model output 506) the information type(s) corresponding to the model input.

In example 500, output 506 comprises a sequence of output tokens 508 comprising attributes and corresponding attribute values. Output 510 comprises, for each information type, a prediction (likelihood, probability, etc.) that the electronic message (from which the input sequence 504 is determined) conveys information corresponding to the information type. Output 510 can be similar to the information provided by the MEC. In example 500, the prediction (including in output 510) can be a likelihood, or probability, a binary indication (e.g., True/False, 0/1, etc.), or a combination.

In example 500, output 510 can be generated by component 512 of model 502. Component 512 can include a mean pooling layer 522 and projection layer 524 positioned after encoder layer 514.

As shown in example 500, input sequence 504 can comprise a sequence of tokens. In accordance with one or more embodiments, the input sequence can be generated by model input generation module 306 from an electronic message, as is discussed in more detail below.

Referring again to FIG. 4, a data extraction request can be received at step 408. The data extraction request can include an electronic message, or include information that can be used to identify an electronic message. By way of a non-limiting example, the request can correspond to one or more electronic messages from a messaging folder of a user (e.g., an inbox folder). By way of a further non-limiting example, a request involving multiple electronic messages can be done by processing each electronic message individually, or in combination.

At step 410, which can be performed by model input generation module 306, model input can be generated. As discussed herein, model input can be generated using data extracted from at least one electronic message.

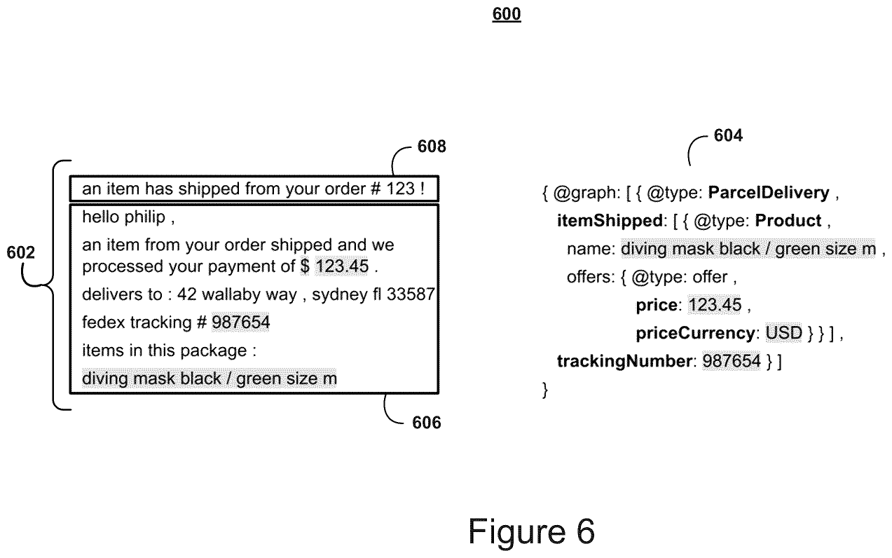

FIG. 6 is a diagram of an exemplary example of a non-limiting embodiment in accordance with some embodiments of the present disclosure. In example 600 of FIG. 6, data 602 extracted from an electronic message comprises the subject 608 and body 606 of the electronic message. In example 600, highlighting is used to demonstrate some examples of correspondence between information input to attribute generation model 502 and information output by attribute generation model 502.

In accordance with one or more embodiments, the model input can be determined (e.g., by model input generation module 306) by analyzing an electronic message and extracting parts (e.g., subject, message body, alt text, etc. contents) based on the analysis.

By way of a further non-limiting example, the electronic message (e.g., an electronic mail message) being analyzed by model input generation module 306 can be expressed using a markup language (e.g., Hypertext Markup Language, or HTML), and module 306 can use an HTML parser to locate and extract parts of the message based on the features of the markup language (e.g., HTML), such as and without limitation markup-language elements (e.g., anchor, head, title, body, image, paragraph, link, etc. elements) and corresponding attributes.

In accordance with at least one such embodiment, information used to generate the model input (e.g., a token sequence) can be extracted from the electronic message via an analysis of elements of the electronic message. By way of a non-limiting example, the message elements can comprise one or more body and header elements included in the electronic message. By way of a further non-limiting example, analysis of the message elements can be used to locate and extract the subject and sender information (used as model input) from the header element(s) of the electronic message, and the body information (used as model input) from the body element(s) of the electronic message.

In accordance with one or more embodiments, the body element(s) of the electronic message can comprise one or more HTML elements and corresponding attributes (of the HTML elements), which can be used to identify and extract the body information (used as model input) from the electronic message.

In accordance with one or more embodiments, other information (in addition to the subject, sender and body information) can be located and extracted from the elements of the electronic message and used as model input. By way of one non-limiting example, an electronic message can comprise (or contain information referencing) one or more images. By way of a further non-limiting example, although not shown in example 600, the body element(s) of an electronic message can comprise at least one HTML element, which can be used to identify an image contained (and/or referenced) in the electronic message. At least one attribute (e.g., an alt attribute) corresponding to an HTML element (of the at least one HTML element) can include a description (e.g., textual description) of the contents of the image. In accordance with one or more embodiments, at least a portion of the model input can be generated based on at least one of the image contents and the description of the image contents.

In accordance with one or more embodiments, the model input can comprise label/information type input from the MEC. The label/information type input can be in the form of a label vector such as that discussed herein in connection with a training instance. In accordance with one or more embodiments, the information type prediction output 510 provided by the attribute generation model 502 can be used with the extraction type prediction output by the MEC to tune the attribute generation model 502 during training.

In accordance with one or more embodiments, model input generation module 306 can use special separator tokens to separate tokens extracted from different portions of the electronic message. By way of a non-limiting example, a special separator token can be used to segment the sequence of tokens corresponding to the subject of the electronic message from the sequence of tokens corresponding to the body of the electronic message.

Referring again to FIG. 4, at step 410, which can be performed by attribute generation module 308 using attribute generation model 502, model output comprising attribute values for at least one set of attributes (corresponding to an extraction type) can be generated.

As discussed herein, attribute generation model 502 can be a sequence-to-sequence model, the model input (e.g., input sequence 504) can be a sequence of tokens, and the model output (output sequence 508) can be another sequence of tokens. The tokens in output sequence 508 can comprise attributes (e.g., names) and attribute values (e.g., values corresponding to the attribute names).

With reference to FIG. 6, as shown in example 600, model output 604 can comprise a set of structured objects. By way of a further non-limiting example, the structured objects can be expressed using a scripting language, such as and without limitation the JavaScript® Object Notation (JSON). In accordance with one or more embodiments, each object can comprise the name of an attribute and a corresponding value. In output 604, for example, tokens name, price, priceCurrency, trackingNumber are examples of attributes and diving mask black/green size m, 123.45, USD, and 987654 are examples of attribute values corresponding (respectively) to the attributes.

In accordance with one or more embodiments, the structured output can include one or more groupings and hierarchies indicating relationships between attributes (and corresponding attribute values). For example, name and price are each related to product by virtue of the structure (e.g., nesting, groupings, etc.) used in output 604.

By way of a further non-limiting example, offers (which is an attribute) can have a composite attribute value comprising one or more attributes and corresponding attribute values (e.g., price: 123.34 and priceCurrency: USD) as well as an information type (e.g., @type offer) for the attributes/attribute values.

As shown in example 600, output from attribute generation model 502 can include information types indicated by token @type. In accordance with one or more embodiments, attribute generation module 502 can use a token @graph to indicate the beginning of the structured output and bracketing for designating hierarchies and relationships among the data. By way of a non-limiting example, the structured output includes product and delivery information and relates the information about the identified product and the identified delivery information.

Referring again to FIG. 4, at step 414, output of attribute generation model 502 can be used to generate a presentation to a user. In accordance with one or more embodiments, the model output (e.g., output 604 comprising attributes and corresponding attribute values) provided by attribute generation model 502 can be used to provide information (e.g., via a user interface) that is based on one or more of the attributes and the corresponding attribute value of each of the one or more attributes.

FIG. 7 includes non-limiting user interface examples populated using attribute generation model output in accordance with one or more embodiments of the present disclosure. Example 700 of FIG. 7 includes examples 702 and 712.

Example 702 includes a user interface such as that provided by an electronic mail (email) messaging user interface, such as might be generated by an email messaging application executed by a client device (e.g., such as a smartphone). The user interface in example 702 includes an inbox presentation including a listing 706 of messages and a displayed notification (e.g., card) 704 comprising a notification informing the user of an upcoming delivery. With reference to FIG. 6, the tracking number in model output 604 can be used (e.g., by electronic messaging system software executing at either the client device, a server or some combination) to retrieve delivery information used to generate the notification 704.

Example 712 includes a user interface which might also be provided by an electronic messaging application executed by a client device. The user interface in example 712 provides an example of combining model output from a number of electronic messages over multiple time periods. The user interface shown in example 712 summarizes a user's monthly total spending as well as spending broken down by category (e.g., shopping, food and dining, etc.) or by merchant.

Model output (e.g., model output 604) determined in accordance with one or more embodiments can be used in connection with a number of applications, such as and without limitation, to identify a user's interests and/or preferences. By way of a non-limiting example, the identified user interests/preferences can be used to personalize a user experience (e.g., a user interface) to include content of interest/preferred by the user. By way of another non-limiting example, a recommendation system can use the identified user interests/preferences in determining one or more recommendations (e.g., content recommendations) for the user. A search engine can use the identified user interests/preferences in identifying and/or ranking search results for presentation to the user. By way of yet another non-limiting example, an electronic commerce (eCommerce) can use the identified user interests/preferences to identify products, services, etc. to offer to the user.

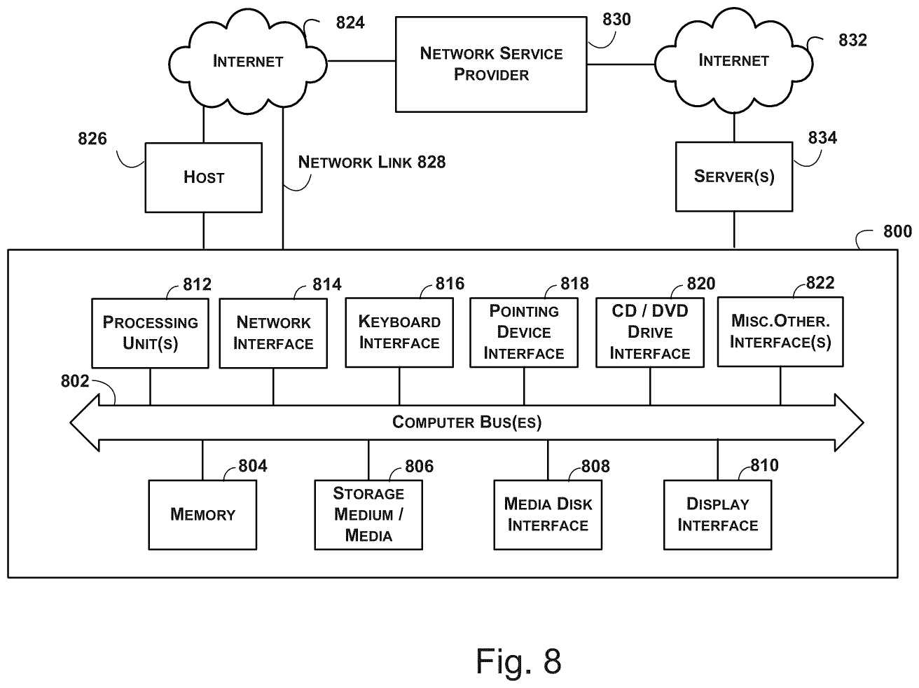

As shown in FIG. 8, internal architecture of a computing system 800 (e.g., computing device(s), computing platform, user devices, set-top box, smart TV and the like) includes one or more processing units, processors, or processing cores, (also referred to herein as CPUs) 812, which interface with at least one computer bus 802. Also interfacing with computer bus 802 are computer-readable storage medium, or media, 806, network interface 814, memory 804, e.g., random access memory (RAM), run-time transient memory, read only memory (ROM), media disk drive interface 808 as an interface for a drive that can read and/or write to media, display interface 810 as interface for a monitor or other display device, keyboard interface 816 as interface for a keyboard, pointing device interface 818 as an interface for a mouse or other pointing device, CD/DVD drive interface 820, and miscellaneous other interfaces (or Misc. Other Interface(s) 822 not shown individually, such as parallel and serial port interfaces and a universal serial bus (USB) interface.

Memory 804 interfaces with computer bus 802 so as to provide information stored in memory 804 to CPU 812 during execution of software programs such as an operating system, application programs, device drivers, and software modules that comprise program code, and/or computer executable process steps, incorporating functionality described herein, e.g., one or more of process flows described herein. CPU 812 first loads computer executable process steps from storage, e.g., memory 804, computer readable storage medium/media 806, removable media drive, and/or other storage device. CPU 812 can then execute the stored process steps in order to execute the loaded computer-executable process steps. Stored data, e.g., data stored by a storage device, can be accessed by CPU 812 during the execution of computer-executable process steps.

Persistent storage, e.g., medium/media 806, can be used to store an operating system and one or more application programs. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 828 typically provides information communication using transmission media through one or more networks to other devices that use or process the information. For example, network link 828 may provide a connection through local network 824 to a host computer 826 or to equipment operated by a Network or Internet Service Provider (ISP) 830. ISP equipment in turn provides data communication services through the public, worldwide packet-switching communication network of networks now commonly referred to as the Internet 832.

A computer called a server host 834 connected to the Internet 832 hosts a process that provides a service in response to information received over the Internet 832. For example, server host 834 hosts a process that provides information representing video data for presentation at a display coupled to display interface 810. It is contemplated that the components of system 800 can be deployed in various configurations within other computer systems, e.g., host and server.

At least some embodiments of the present disclosure are related to the use of computer system 800 for implementing some or all of the techniques described herein. According to one embodiment, those techniques are performed by computer system 800 in response to processing unit 812 executing one or more sequences of one or more processor instructions contained in memory 804. Such instructions, also called computer instructions, software and program code, may be read into memory 804 from another computer-readable medium 806 such as storage device or network link. Execution of the sequences of instructions contained in memory 804 causes processing unit 812 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 800. Computer system 800 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 812 as it is received, or may be stored in memory 804 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
obtaining, by a computing device, a corpus of electronic messages;
generating, by the computing device, training data comprising a set of training instances using the corpus of electronic messages, each training instance, of the set of training instances, comprising data extracted from a respective electronic message from the corpus of electronic messages and labeling information indicating at least one type of information included in the respective electronic message;
training, by the computing device, an attribute generation model using the training data;
analyzing, by the computing device, an electronic message addressed to a recipient and generating model input based on the analysis;
obtaining, by the computing device, model output from the attribute generation model based on the model input, the model output comprising, in connection with a respective type of information, a set of attribute values from the electronic message determined, by the attribute generation model, to correspond to a set of attributes corresponding to the respective type of information; and
generating, via the computing device, a presentation, for display at a user computing device of the recipient, the presentation comprising information based at least in part on the set of attribute values from the electronic message determined, by the attribute generation model, to correspond to the set of attributes.

2. The method of claim 1, further comprising:
communicating, via the computing device and over a network, the presentation to the user computing device, the communicating causing the presentation to be displayed in a user interface at the user computing device.

3. The method of claim 1, the presentation is displayed in an electronic mail messaging user interface.

4. The method of claim 3, the presentation comprising at least one item that is an aggregate of data extracted from multiple electronic mail messages using the attribute generation model.

5. The method of claim 1, the model output further comprising information identifying at least one relationship among the set of attributes.

6. The method of claim 5, the model output is represented using a scripting language to associate a respective attribute value with a corresponding attribute and the at least one relationship is indicated using attribute nesting.

7. The method of claim 1, the model output further comprising information identifying the respective type of information that is determined by the attribute generation model using the model input.

8. The method of claim 1, generating training data further comprising:
analyzing, by the computing device, the respective electronic message, from the corpus of electronic messages, to identify header and body elements of the electronic message; and
generating, by the computing device, a corresponding training instance using information extracted from the header and body elements of the electronic message.

9. The method of claim 1, analyzing the electronic message from a message folder further comprising:
identifying, by the computing device, header and body elements of the analyzed electronic message; and
generating, by the computing device, the model input using information extracted from the header and body elements of the analyzed electronic message.

10. The method of claim 9, analyzing the electronic message from a message folder further comprising:
analyzing, by the computing device, one or more HTML elements and corresponding attributes included in the body element of the analyzed electronic message, at least a portion of the model input being generated based on the analysis of the one or more HTML elements and corresponding attributes in the analyzed electronic message.

11. The method of claim 10, analyzing one or more HTML elements further comprising:
identifying, by the computing device, an image using the one or more HTML elements;
identifying, by the computing device, a description of the identified image using at least one attribute corresponding the one or more HTML elements; and
generating, by the computing device, the at least a portion of the model input based on the identified image and the identified description.

12. The method of claim 1, the attribute generation model being further trained to identify the respective type of information.

13. The method of claim 12, the attribute generation model comprising an information-type prediction component enabling the attribute generation model to identify the respective type of information.

14. The method of claim 1, wherein the data extracted from the respective electronic message comprises subject, sender and body information, and the model input comprises subject, sender and body information.

15. A non-transitory computer-readable storage medium tangibly encoded with computer-executable instructions that when executed by a processor associated with a computing device perform a method comprising:
obtaining a corpus of electronic messages;
generating training data comprising a set of training instances using the corpus of electronic messages, each training instance, of the set of training instances, comprising data extracted from a respective electronic message from the corpus of electronic messages and labeling information indicating at least one type of information included in the respective electronic message;
training an attribute generation model using the training data;
analyzing an electronic message addressed to a recipient and generating model input based on the analysis;
obtaining model output from the attribute generation model based on the model input, the model output comprising, in connection with a respective type of information, a set of attribute values from the electronic message determined, by the attribute generation model, to correspond to a set of attributes corresponding to the respective type of information; and
generating a presentation, for display at a user computing device of the recipient, the presentation comprising information based at least in part on the set of attribute values from the electronic message determined, by the attribute generation model, to correspond to the set of attributes.

16. The non-transitory computer-readable storage medium of claim 15, the method further comprising:
communicating the presentation to the user computing device, the communicating causing the presentation to be displayed in a user interface at the user computing device.

17. The non-transitory computer-readable storage medium of claim 15, the presentation is displayed in an electronic mail messaging user interface.

18. The non-transitory computer-readable storage medium of claim 17, the presentation comprising at least one item that is an aggregate of data extracted from multiple electronic mail messages using the attribute generation model.

19. The non-transitory computer-readable storage medium of claim 15, the model output further comprising information identifying the respective type of information that is determined by the attribute generation model using the model input.

20. A computing device comprising:
a processor; and
a non-transitory storage medium for tangibly storing thereon program logic for execution by the processor, the program logic comprising:
obtaining logic executed by the processor for obtaining a corpus of electronic messages;
generating logic executed by the processor for generating training data comprising a set of training instances using the corpus of electronic messages, each training instance, of the set of training instances, comprising data extracted from a respective electronic message from the corpus of electronic messages and labeling information indicating at least one type of information included in the respective electronic message;
training logic executed by the processor for training an attribute generation model using the training data;
analyzing logic executed by the processor for analyzing an electronic message addressed to a recipient and generating model input based on the analysis;
obtaining logic executed by the processor for obtaining model output from the attribute generation model based on the model input, the model output comprising, in connection with a respective type of information, a set of attribute values from the electronic message determined, by the attribute generation model, to correspond to a set of attributes corresponding to the respective type of information; and
generating logic executed by the processor for generating a presentation, for display at a user computing device of the recipient, the presentation comprising information based at least in part on the set of attribute values from the electronic message determined, by the attribute generation model, to correspond to the set of attributes.
